(19) United States
(12) Patent Application Publication
(10) Pub. No.: US 2020/0292743 A1
(43) Pub. Date: Sep. 17, 2020

(54) WAVEGUIDE ENERGY CONVERSION ILLUMINATION SYSTEM

(71) Applicant: BAMBU VAULT LLC, Lowell, MA (US)

(72) Inventors: M. Glenn HORNER, West Roxbury, MA (US); Ying LI, Westmont, IL (US); Satish AGRAWAL, Sudbury, MA (US)

(73) Assignee: BAMBU VAULT LLC, Lowell, MA (US)

(21) Appl. No.: 16/761,153

(22) PCT Filed: Nov. 1, 2018
(86) PCT No.: PCT/US2018/058641

§ 371 Date: May 1, 2020

Related U.S. Application Data
(60) Provisional application No. 62/580,970, filed on Nov. 2, 2017.

(51) Int. Cl. F21V 8/00; G03B 21/20; F21V 7/26

(52) U.S. Cl. CPC G02B 6/0003; F21V 7/26; G03B 21/2066

(57) ABSTRACT

In an embodiment an illumination system includes an illumination source that emits a primary electromagnetic radiation having a spectrum of wavelengths and an energy conversion layer that converts at least a portion of the primary electromagnetic radiation to a secondary electromagnetic radiation having a different spectrum of wavelengths than the primary electromagnetic radiation. The energy conversion layer may have a viewing surface, a bottom surface opposed to the viewing surface, and an edge surface normal to the viewing surface and the bottom surface. The primary electromagnetic radiation may be incident on the edge surface of the energy conversion layer.

### CROSS-REFERENCE TO RELATED APPLICATIONS

This application claims the benefit of U.S. Provisional Patent Application No. 62/580,970, filed Nov. 2, 2017, which is incorporated herein by reference in its entirety.

### BACKGROUND OF THE INVENTION

The present invention generally relates to illumination systems, and in particular illumination systems comprising an energy conversion layer.

A previous publication has disclosed the functions of light propagation, light conversion and light extraction from energy conversion layers of light originating from a solid state light source (U.S. Pat. No. 8,415,642). Another publication has disclosed the use of a light guide with such a source to provide converted light from an energy conversion layer (U.S. Pat. No. 8,664,624). In the latter, the light guide is a stand-alone element and plays no other role than the delivery of light to the energy conversion film.

Energy conversion layers have been described in U.S. Pat. No. 8,415,642. As described, such layers convert the electromagnetic energy spectrum of a principle radiation source into a new radiation, having a spectrum generally of a higher average wavelength, through a cascade of absorption/emission events by one or a set of photoluminescent materials, for example organic fluorescent dyes. The energy conversion layer comprises a polymer and a first photoluminescent material. The first photoluminescent material is characterized by a first Stokes shift and a first radiation absorption spectrum. The first radiation absorption spectrum at least partially overlaps with the spectrum of the primary electromagnetic radiation. Typically, successive energy conversion in the energy conversion layer occurs through successive energy conversion materials that are characterized by overlapping emission and absorption spectra. It is not required in all instances to cascade energy through a series of emission and reabsorption steps, and one may achieve the resultant energy conversion by way of Förster transfer (U.S. Pat. No. 8,519,359). The converted light, in all cases, is emitted from the photoluminescent material isotropically, that is, in all directions.

There exists a need for a simplified illumination system.

### BRIEF SUMMARY OF THE INVENTION

In an embodiment an illumination system comprises an illumination source that emits a primary electromagnetic radiation having a spectrum of wavelengths and an energy conversion layer that converts at least a portion of the primary electromagnetic radiation to a secondary electromagnetic radiation having a different spectrum of wavelengths than the primary electromagnetic radiation. The energy conversion layer may have a viewing surface, a bottom surface opposed to the viewing surface, and an edge surface normal to the viewing surface and the bottom surface. The primary electromagnetic radiation may be incident on the edge surface of the energy conversion layer.

In some embodiments the energy conversion layer of the illumination system comprises a photoluminescent material dispersed in a matrix material. The photoluminescent material may have an absorption spectrum that overlaps with at least a portion of the spectrum of wavelengths of the primary electromagnetic radiation. In some embodiments the photoluminescent material of the energy conversion layer comprises a dye, for example an organic fluorescent dye. In some embodiments the organic fluorescent dye is selected from rylenes, xanthenes, porphyrins, and phthalocyanines.

In some embodiments the energy conversion layer of the illumination system receives and propagates the primary electromagnetic radiation by total internal reflection. In some embodiments the primary electromagnetic radiation propagates with a total internal reflection of about 70% or more of the primary electromagnetic radiation. In some embodiments the energy conversion layer propagates the secondary electromagnetic radiation with a total internal reflection of about 70% or more of the secondary electromagnetic radiation. In some embodiments the energy conversion layer of the illumination system further comprises a scattering component.

In some embodiments the illumination source of the illumination system is optically decoupled from the energy conversion layer. For example, the illumination source may be separated from the energy conversion layer by a layer of air, nitrogen, noble gas, other gas, or mixture thereof, or vacuum. In some embodiments the illumination source is separated from the energy conversion layer by a distance of less than 3 mm. In other embodiments the illumination source of the illumination system is optically coupled to the energy conversion layer.

In another embodiment the illumination system further includes a reflective layer covering at least a portion of the bottom surface of the energy conversion layer. In some embodiments the illumination system further includes a diffusion layer covering at least a portion of the viewing surface of the energy conversion layer. In some embodiments the illumination system further includes an optical scattering component. For example, the optical scattering component may include titanium dioxide, zirconium dioxide, barium sulfate, glass, or a combination thereof. The optical scattering component may be disposed on a surface of the energy conversion layer, within the energy conversion layer, or both on the surface and within the energy conversion layer.

In some embodiments an illumination system includes an illumination source that emits a primary electromagnetic radiation having a spectrum of wavelengths; an energy conversion layer that converts at least a portion of the primary electromagnetic radiation to a secondary electromagnetic radiation having a different spectrum of wavelengths than the primary electromagnetic radiation; and an optical element that guides the primary electromagnetic radiation into the energy conversion layer. In some embodiments the energy conversion layer has a viewing surface, a bottom surface opposed to the viewing surface, and an edge surface normal to the viewing surface and the bottom surface. In some embodiments the primary electromagnetic radiation is incident on the bottom surface of the energy conversion layer. In some embodiments the illumination source is optically decoupled from the energy conversion layer. In some embodiments the illumination source is separated from the energy conversion layer by a layer of air, nitrogen, noble gas, other gas, or mixture thereof, or vacuum.

In some embodiments the energy conversion layer of the illumination system comprises a photoluminescent material dispersed in a matrix material. The photoluminescent material may have an absorption spectrum that overlaps with at least a portion of the spectrum of wavelengths of the primary electromagnetic radiation. In some embodiments the photoluminescent material of the energy conversion layer comprises a dye, for example an organic fluorescent dye. In some embodiments the organic fluorescent dye is selected from rylenes, xanthenes, porphyrins, and phthalocyanines.

In some embodiments the energy conversion layer of the illumination system receives and propagates the primary electromagnetic radiation by total internal reflection. In some embodiments the primary electromagnetic radiation propagates with a total internal reflection of about 70% or more of the primary electromagnetic radiation. In some embodiments the energy conversion layer propagates the secondary electromagnetic radiation with a total internal reflection of about 70% or more of the secondary electromagnetic radiation. In some embodiments the energy conversion layer of the illumination system further comprises a scattering component.

In some embodiments the illumination system comprises one or more optical elements. In some embodiments the optical element of the illumination system comprises a refractive element. In some embodiments the optical element of the illumination system comprises a prism. In some embodiments the optical element of the illumination system comprises a lens. In some embodiments the optical element of the illumination system comprises a diffractive element.

In some embodiments the illumination system further includes a reflective layer covering at least a portion of the bottom surface of the energy conversion layer. In some embodiments the illumination system further includes a diffusion layer covering at least a portion of the viewing surface of the energy conversion layer.

In another embodiment an illumination system includes an illumination source that emits a primary electromagnetic radiation having a spectrum of wavelengths, and an energy conversion layer that converts at least a portion of the primary electromagnetic radiation to a secondary electromagnetic radiation having a different spectrum of wavelengths than the primary electromagnetic radiation. In some embodiments the energy conversion layer has a viewing surface, a bottom surface opposed to the viewing surface, and an edge surface normal to the viewing surface and the bottom surface. In some embodiments the primary electromagnetic radiation is incident on a bottom surface of the energy conversion layer. In some embodiments the energy conversion layer is optically coupled to the illumination source, for example the illumination source may be optically coupled to the bottom surface of the energy conversion layer. For example, the illumination source may abut the energy conversion layer.

In some embodiments the energy conversion layer of the illumination system comprises a photoluminescent material dispersed in a matrix material. The photoluminescent material may have an absorption spectrum that overlaps with at least a portion of the spectrum of wavelengths of the primary electromagnetic radiation. In some embodiments the photoluminescent material of the energy conversion layer comprises a dye, for example an organic fluorescent dye. In some embodiments the organic fluorescent dye is selected from rylenes, xanthenes, porphyrins, and phthalocyanines.

In some embodiments the energy conversion layer of the illumination system receives and propagates the primary electromagnetic radiation by total internal reflection. In some embodiments the primary electromagnetic radiation propagates with a total internal reflection of about 70% or more of the primary electromagnetic radiation. In some embodiments the energy conversion layer propagates the secondary electromagnetic radiation with a total internal reflection of about 70% or more of the secondary electromagnetic radiation. In some embodiments the energy conversion layer of the illumination system further comprises a scattering component.

In some embodiments the illumination system further includes a reflective layer covering at least a portion of the bottom surface of the energy conversion layer. In some embodiments the illumination system further includes a diffusion layer covering at least a portion of the viewing surface of the energy conversion layer. In some embodiments the illumination system further includes an optical scattering component. For example, the optical scattering component may include titanium dioxide, zirconium dioxide, barium sulfate, glass, or a combination thereof. The optical scattering component may be disposed on a surface of the energy conversion layer, within the energy conversion layer, or both on the surface and within the energy conversion layer.

### BRIEF DESCRIPTION OF THE SEVERAL VIEWS OF THE DRAWINGS

The foregoing summary, as well as the following detailed description of embodiments of the illumination system, will be better understood when read in conjunction with the appended drawings of an exemplary embodiment. It should be understood, however, that the invention is not limited to the precise arrangements and instrumentalities shown.

In the drawings:

FIG. 1 is a side elevation view of an illumination system in accordance with an exemplary embodiment of the present invention;

FIG. 2A is a side elevation view of an illumination system in accordance with an exemplary embodiment of the present invention;

FIG. 2B is a side elevation view of an illumination system in accordance with an exemplary embodiment of the present invention;

FIG. 3 is a side elevation view of an illumination system in accordance with an exemplary embodiment of the present invention;

FIG. 4 is a side elevation view of an illumination system in accordance with an exemplary embodiment of the present invention;

FIG. 5 is a side elevation view of an illumination system in accordance with an exemplary embodiment of the present invention; and

FIG. 6 is a side elevation view of an illumination system in accordance with an exemplary embodiment of the present invention.

### DETAILED DESCRIPTION OF THE INVENTION

An illumination system in accordance with embodiments of the invention generally includes at least one illumination source and at least one energy conversion layer. In some embodiments the illumination source may emit a primary electromagnetic radiation having a spectrum of wavelengths. The energy conversion layer converts at least a portion of the primary electromagnetic radiation to a secondary electromagnetic radiation having a different spectrum of wavelengths than the primary electromagnetic radiation. The energy conversion layer may also receive and propagate at least a portion of the primary electromagnetic radiation by total internal reflection. It has been discovered that in some embodiments, under certain conditions of transparency and refractive index, the light in the energy conversion layer can include guided modes that can be extracted from the face of the energy conversion layer to provide useful light at angles substantially perpendicular to the face of the layer. In some embodiments the illumination system includes a scattering component through which the primary electromagnetic radiation and/or secondary electromagnetic radiation may be extracted.

In some embodiments the illumination source emits a primary electromagnetic radiation in the direction of the energy conversion layer. The primary electromagnetic radiation is generally emitted along an optical axis.

In further embodiments, the at least one illumination source includes a plurality of illumination sources and the at least one energy conversion layer includes a plurality of energy conversion layers. The plurality of energy conversion layers may be arranged, for example, in a multilayer structure. In some embodiments the illumination source of the illumination system comprises one or more light emitting elements that provide a primary electromagnetic radiation having a principle wavelength that partially or fully overlaps with the absorption spectrum of at least one of the one or more energy conversion layers of the multilayer structure. Acceptable light emitting elements may include any element, along with any typical associated packaging or housing, that is capable of providing electromagnetic radiation, such as, but not limited to, a chemiluminescent source or an electroluminescent source, e.g. a light emitting diode (LED) such as a gallium nitride LED. It should be noted that in the instances where the luminous system of the present teachings comprises more than one illumination source, it is not required that each illumination source be the same, rather multiple and distinct illumination sources may be used within the same luminous system.

In some embodiments the primary electromagnetic radiation of the illumination source of the illumination system comprises a spectrum of wavelengths. In some embodiments the primary electromagnetic radiation has a peak wavelength, which refers to the wavelength where the spectrum reaches its highest intensity. In some embodiments the primary electromagnetic radiation has an average wavelength of the spectrum of wavelengths. In some embodiments the primary electromagnetic radiation comprises visible light, ultraviolet light, infrared light, or a combination thereof. In some embodiments the spectrum of wavelengths comprises wavelengths between about 380 nm to about 750 nm, about 380 nm to about 495 nm, about 420 nm to about 490 nm, about 315 nm to about 400 nm, or about 365 nm to about 410 nm. In some embodiments the peak wavelength or average wavelength is in the range about 380 nm to about 750 nm, about 380 nm to about 495 nm, about 420 nm to about 490 nm, about 315 nm to about 400 nm, or about 365 nm to about 410 nm. The primary electromagnetic radiation may be directed along an optical axis. In some embodiments, the distribution of radiation about the optical axis may be a cone with an angle of dispersion. In other embodiments, the distribution of radiation may be essentially collimated with the optical axis. In some embodiments the primary electromagnetic radiation is incident on or enters through the edge surface of the energy conversion layer. In other embodiments the primary electromagnetic radiation is incident on or enters through the bottom surface of the energy conversion layer.

In some embodiments the at least one energy conversion layer is configured to absorb at least a portion of incident electromagnetic radiation, and converts such radiation to a secondary electromagnetic radiation having a different spectrum. In some embodiments incident electromagnetic radiation comprises primary electromagnetic radiation from the at least one illumination source. In some embodiments the secondary electromagnetic radiation has a peak wavelength. In some embodiments the secondary electromagnetic radiation has an average wavelength of the spectrum of wavelengths. In some embodiments the peak wavelength of the secondary electromagnetic radiation is longer than the peak wavelength of the primary electromagnetic radiation. In some embodiments the average wavelength of the secondary electromagnetic radiation is longer than the average wavelength of the primary electromagnetic radiation.

In some embodiments the at least one energy conversion layer of the illumination system may have a viewing surface, a bottom surface opposed to the viewing surface, and an edge surface that is not parallel to either the bottom surface or the viewing surface. The viewing surface refers to the surface from which the secondary electromagnetic radiation is emitted and visually perceived by a viewer. In some embodiments, a portion of the primary electromagnetic radiation provided by the one or more illumination sources may also be emitted from the viewing surface in combination with the secondary electromagnetic radiation. This may occur, for example, if the energy conversion layer does not convert all of the primary electromagnetic radiation. In other embodiments, the illumination system is configured such that a minimal amount or none of the primary electromagnetic radiation is emitted from the viewing surface such that, for example, the light that is visually perceived by the viewer is comprised entirely of or mostly of the secondary electromagnetic radiation. In some embodiments the bottom surface and viewing surface are opposed to each other. In some embodiments, the viewing surface and the bottom surface may be parallel or substantially parallel to each other. In other embodiments the viewing surface and the bottom surface are oriented such that they are not parallel to each other. in some embodiments, the viewing surface and/or the bottom. surface are planar. In some embodiments, the viewing surface and/or the bottom. surface are curved surfaces. in some embodiments, the viewing surface has a larger surface area than the edge surface. In some embodiments, the viewing surface has a larger surface area than the bottom surface. In some embodiments the edge surface is substantially normal to the viewing surface and/or the bottom surface. In some embodiments the edge surface is oblique to the bottom surface, the viewing surface, or both the bottom surface and the viewing surface. In some embodiments the energy conversion layer comprises a film. The energy conversion layer can be sized and dimensioned according to the need of the user. In some embodiments the energy conversion layer has a thickness (i.e., distance between the bottom surface and viewing surface) of less than 5 mm, less than 3 mm, less than 1 mm, less than 0.5 mm, less than 0.1 mm, about 5 mm, about 3 mm, about 1 mm, about 0.5 mm, about 0.1 mm, between 0.1 mm and 10 mm, between 0.1 mm and 5 mm, between 0.1 mm and 3 mm, or between 0.1 mm and 1 mm.

In some embodiments of the illumination system, the primary electromagnetic radiation is incident on the edge surface of the energy conversion layer. In such embodiments the optical axis of the primary electromagnetic radiation may be directed toward the edge surface of the energy conversion layer. In some such edge-injected light embodiments, the energy conversion layer may convert all or substantially all of the primary electromagnetic radiation and accordingly the color of the light emitted from the viewing surface may include minimal to no primary electromagnetic radiation. In some embodiments where the illumination source is not aligned in the direction of the viewer (i.e., the primary electromagnetic radiation is not incident on the bottom surface), such as some edge-injected embodiments, minimal or no primary electromagnetic radiation is emitted from the viewing surface. In some such embodiments, the light emitted from the viewing surface will primarily be secondary electromagnetic radiation and other light converted by the energy conversion layer. In general, white light is provided by mixing of the primary electromagnetic radiation with secondary electromagnetic radiation and/or other converted light emitted from the viewing surface. Without being bound by theory, the energy conversion layer may act as a waveguide, retaining the primary electromagnetic radiation in the energy conversion layer until it is converted to secondary electromagnetic radiation by the photoluminescent material. In some embodiments, primary electromagnetic radiation that is not guided within the energy conversion layer may escape via the viewing surface within a few centimeters, e.g., 10 cm, 5 cm, or 2 cm of the edge surface and in practice may be disguised or hidden by a cover over that portion of the viewing surface of the energy conversion layer. Because there is limited or no mixing of converted light and primary electromagnetic radiation emitted from the viewing surface in such edge-injected embodiments, the light emitted from the viewing surface in edge-injected systems is typically not white, although in some embodiments the light emitted from the viewing surface in edge-injected systems may be white. In some embodiments light emitted from an edge-injected illumination system is red, orange, yellow, green, blue, or deep blue. An advantage of edge injected embodiments is that there is no bright spot on the viewing surface caused by the illumination source.

In other embodiments of the illumination system, the primary electromagnetic radiation is incident on the bottom surface of the energy conversion layer. In such embodiments the optical axis of the primary electromagnetic radiation may be directed toward the bottom surface of the energy conversion layer.

In some embodiments the at least one energy conversion layer of the illumination system comprises a photoluminescent material. In some embodiments the photoluminescent material of the energy conversion layer of the illumination system may have an absorption spectrum that overlaps with at least a portion of the wavelengths of the incident electromagnetic radiation, for example the photoluminscent material may have an absorption spectrum that overlaps with at least the peak wavelength of the primary electromagnetic radiation. The photoluminescent material of the energy conversion layer of the illumination system may comprise a phosphorescent material, a fluorescent material, or any combination thereof.

Suitable photoluminescent materials useful in the energy conversion layer of the illumination system include, but are not limited to, rylenes, xanthenes, porphyrins, cyanines, violanthrones, or others, preferably photoluminescent materials having high quantum yield properties. Rylene dyes include, but are not limited to, perylene esters or diimide materials, such as 3-cyanoperylene-9,10-dicarboxylic acid 2′,6′-diiosopropylanilide, 3,4,9,10-perylene tetracarboxylic acid bis(2′,6′-diiso propyl) anilide, 1,6,7,12-tetraphenoxy-N,N′-di(2′,6′-diisopropylphenyl)-3,4:9,10-perylenediimide, etc. Xanthene dyes include, but are not limited to, Rhodamine B, Eosin Y, or fluorescein. Porphyrin dyes include, for example, 5,10,15,20-tetraphenyl-21H,23H-tetraphenylporphine, 2,3,7,8,12,13,17,18-octaethyl-21H,23H-porphine, etc. Cyanine dyes include, for example, 3,3′-diethyloxadicarbocyanine iodide, 3,3′-diethyloxacarbocyanine iodide, IR 775, IR 792, etc. Violanthrones include, for example, violanthrone 78, violanthrone 79, etc.

In some embodiments the energy conversion layer of the illumination system comprises a matrix material into which the photoluminescent material may be dispersed. In some embodiments the matrix material comprises a polymer or a glass. Suitable polymers include acrylates, polyurethanes, polycarbonates, polyvinyl chlorides, silicone resins, polyesters, for example polyethylene terephthalate (“PET”), (bisphenol A) polycarbonates, styrenes, acrylic polymers, and other common polymers. In some embodiments the matrix material is poly(methyl methacrylate) (“PMMA”).

In some embodiments the at least one energy conversion layer of the illumination system may act as a light guide. Light guiding can occur when light in a first material reaches an interface between the first material and a second material and due to the difference in indices of refraction of the two materials, the light is reflected at the interface parallel to the interface or back into the first material. The relationship between the angle of incidence and the angle of transmittance is given by Snell's Law: sin θ₂=(n₁/n₂) sin θ₁ where n₁ is the refractive index of the first material, θ₁ is the angle of incidence, n₂ is the refractive index of the second material, and θ₂ is the angle of transmittance. As the angle of incidence θ₁ increases, a point will be reached where the ray is refracted to an angle of 90°, i.e. the light will remain in the original medium. This angle is defined as the critical angle, θ_{c}. Rays incident to the interface at angles greater than or equal to the critical angle will be totally internally reflected causing the light to travel generally in a direction parallel to the interface. A light guide may propagate electromagnetic radiation by total internal reflection.

In some embodiments the energy conversion layer of the illumination system acts as a light guide of the primary electromagnetic radiation. In some embodiments approximately 75% of the primary electromagnetic radiation will be totally internally reflected at the interface between the energy conversion layer and a second material (e.g., air). In some embodiments at least 65%, at least 70%, at least 75%, at least 80%, at least 85%, at least 90%, at least 95%, about 65%, about 70%, about 80%, about 85%, about 90%, about 95%, about 99%, 70% to 100%, 75% to 95%, 80% to 90% of the primary electromagnetic radiation is totally internally reflected at the interface between the energy conversion layer and a second material. Accordingly, in some embodiments the energy conversion layer can be considered to be a light guide of the primary light.

In some embodiments the energy conversion layer of the illumination system acts as a light guide of the secondary electromagnetic radiation. In some embodiments of the illumination system, primary electromagnetic radiation from an illumination source is used to excite an emission of a secondary electromagnetic radiation from a photoluminescent material contained in the energy conversion layer. In some such embodiments, the photoluminescent material itself acts as a light source, such as an isotropic light source contained within the energy conversion layer. In embodiments where the photoluminescent material acts as an isotropic light source, the photoluminescent material may deliver the secondary electromagnetic radiation substantially uniformly in a sphere around the excited photoluminescent material. As that sphere reaches the interface between the energy conversion layer and a second material (e.g., air) rays of the secondary electromagnetic radiation at angles less than the critical angle will be transmitted into the second material. This population of rays is described by the spherical cap defined by rotation of the critical angle around the surface normal. All rays at greater than the critical angle will be totally internally reflected, so that the efficacy of light guiding is determined by the percentage of total area of the sphere that lacks the caps. In some embodiments approximately 75% of the secondary electromagnetic radiation will be totally internally reflected at the interface between the energy conversion layer and a second material (e.g., air). In some embodiments at least 65%, at least 70%, at least 75%, at least 80%, at least 85%, at least 90%, at least 95%, about 65%, about 70%, about 80%, about 85%, about 90%, about 95%, about 99%, 70% to 100%, 75% to 95%, 80% to 90% of the secondary electromagnetic radiation is totally internally reflected at the interface between the energy conversion layer and a second material. Accordingly, in some embodiments the energy conversion film can be considered to be a light guide of the converted light.

In some embodiments the energy conversion layer of the illumination system is considered to guide light if at least 65%, at least 70%, or at least 75%, of the light is propagated in the energy conversion layer a distance of at least 3 wavelengths of that light. In some embodiments, once light is guided it will remain guided until it encounters a scattering element that changes the vector of propagation, such as a scattering element in the energy conversion layer or on a surface of the energy conversion layer.

In some embodiments the waveguiding effect of the energy conversion layer can provide the advantage of producing light of a uniform color across at least a portion of the viewing surface. In some embodiments the color can be measured by a colorimeter. The uniformity of color can be measured based on the “just noticeable difference” (“JND”) between two points on the viewing surface using the MacAdam ellipse for the color. Light may be considered uniform if there are 5 or less, 4 or less, 3 or less, 2 or less, or 1 or less JND between the two points. Alternatively, the uniformity of color can be measured based on the change in energy of the light between two points, as measured by a colorimeter. In certain embodiments, when the absorption spectrum of the photoluminescent material overlaps with its optical emission (e.g., the secondary electromagnetic radiation, tertiary electromagnetic radiation, etc.), then this spectrum (defined by the overlap) can be reabsorbed and converted to the longer wavelength emission until the spectrum of the guided light contains only wavelengths that cannot be absorbed, to produce a light of uniform color.

In some embodiments of the illumination system the illumination source is optically coupled to the energy conversion layer. Optical coupling may occur where there is no material between the outermost surface of the light emitting element of the illumination source and the energy conversion layer having a substantially lower refractive index than the outermost surface of the light emitting element and/or the energy conversion layer. In some embodiments the light emitting element of the illumination source abuts the energy conversion layer so that there is no intervening material between the outermost surface of the light emitting element and the energy conversion layer. In some embodiments the outermost surface of the light emitting element is adhered to the energy conversion layer by a material having substantially the same index of refraction as the outermost surface of the light emitting element and/or the energy conversion layer. In some embodiments the outermost surface of the light emitting element is adhered to the energy conversion layer by a material that has an index of refraction within about ±0.1 of the outermost surface of the light emitting element and/or the energy conversion layer. In some embodiments an optical element having an index of refraction within about ±0.1 of the outermost surface of the light emitting element and/or the energy conversion layer may be positioned between the light emitting element of the illumination source and the energy conversion layer such that there is no material having a significantly different (e.g., greater than about ±0.3) index of refraction between the outermost surface of the light emitting element of the illumination source, the optical element, and the energy conversion layer. In some embodiments an optical element may include a lens, prism etc., and may have refractive and/or diffractive characteristics. In some embodiments the illumination source is optically coupled to the edge surface of the energy conversion layer. In other embodiments the illumination source is optically coupled to the bottom surface of the energy conversion layer. The illumination source may be optically coupled directly to the edge or bottom surface of the energy conversion layer (e.g., via abutment with) or indirectly via an optical element disposed between the illumination source and the edge or bottom surface of the energy conversion layer.

In some embodiments of the illumination system where the illumination source is optically coupled to the energy conversion layer, the illumination source may be a Lambertian light source that is optically coupled to a first surface (e.g., the edge surface or bottom surface) of the energy conversion layer. Primary electromagnetic radiation from such a Lambertian illumination source that is oriented so that its optical axis is essentially normal to a first surface (e.g., edge surface or bottom surface) of the energy conversion layer can have a significant amount of light that is totally internally reflected at a second surface (e.g., viewing surface) of the energy conversion layer that has an interface with a second material having a significantly lower index of refraction, e.g., air. For example, in some embodiments wherein the illumination source is optically coupled to the energy conversion layer, the rays of primary electromagnetic radiation from the illumination source enter the energy conversion layer unperturbed, so that the light can be treated as if the illumination source is contained within the energy conversion layer itself; the fraction of guided rays is determined similarly to that described above for the photoluminescent material contained in the energy conversion film, so that approximately 75% of the light is guided. In some embodiments where the illumination source is optically coupled to the energy conversion layer, at least 65%, at least 70%, at least 75%, at least 80%, at least 85%, at least 90%, at least 95%, about 65%, about 70%, about 80%, about 85%, about 90%, about 95%, about 99%, 70% to 100%, 75% to 95%, 80% to 90% of the primary electromagnetic radiation is totally internally reflected.

In other embodiments of the illumination system the illumination source is optically decoupled from the energy conversion layer. Optical decoupling may occur where there is a material between the outermost surface of the light emitting element of the illumination source and the energy conversion layer having a significantly different (e.g., greater than about ±0.3) refractive index than the outermost surface of the light emitting element and/or the energy conversion layer. In some embodiments optical decoupling may occur where there is a material between the outermost surface of the light emitting element and the energy conversion layer having a substantially lower (e.g., greater than about 0.3 lower) or substantially higher (e.g., greater than about 0.3 higher) refractive index than the outermost surface of the light emitting element and/or the energy conversion layer. One such material that has a lower index of refraction and can be considered to optically decouple the illumination source from the energy conversion layer is air. Other materials that may be considered to optically decouple the illumination source from the energy conversion layer include nitrogen gas, noble gases, other gases, or mixtures thereof. In another embodiment a vacuum between the illumination source and energy conversion layer can serve to decouple the illumination source from the energy conversion layer. In some embodiments where the illumination source is optically decoupled from the energy conversion layer, the illumination system further comprises an optical element that directs the primary electromagnetic radiation into the energy conversion layer. In some embodiments the optical element may include a lens, prism, etc. The optical component may be a lens or prism (e.g., a refractive element that changes the direction of light incident on the refractive element), or it could be an optical grating (e.g., a diffractive element) that relies on diffraction of the light to change its direction. Diffractive elements can include holographic elements. In some embodiments the optical element may have refractive and/or diffractive characteristics.

In some embodiments the energy conversion layer of the illumination system comprises an optical scattering component. An optical scattering component may serve to extract light (e.g., the primary electromagnetic radiation and/or secondary electromagnetic radiation) from the energy conversion layer. In some embodiments the energy conversion layer acts as a light guide in which the primary and/or secondary electromagnetic radiation is totally internally reflected. Light from guided modes can be usefully extracted from the energy conversion layer in a number of ways. In some embodiments an optical scattering component is a mechanism by which the guided light can be extracted to that it can be viewed. In some embodiments an optical scattering component comprises an optical structure that is etched or embossed onto the surface (e.g., the viewing surface) of the energy conversion layer to redirect evanescent modes of the primary and/or secondary electromagnetic radiation to a direction essentially normal to the surface (e.g., viewing surface) of the energy conversion layer, thereby producing rays which can successfully exit the light guide. In some embodiments, surface structures or patterns that can extract light can be introduced by embossing the heated energy conversion layer with a cold, patterned roller. In other embodiments, surface structures can be introduced by laser etching of the surface of the energy conversion layer. In some embodiments an optical scattering component comprises a surface structure comprising a plurality of lines. In some embodiments an optical scattering component comprises a surface structure comprising a plurality of dots.

In other embodiments, optical scattering components can be included within or on the surface of the light guide that can similarly produce rays that are essentially normal to the light guide surface, providing a mechanism for light extraction. For example, in some embodiments a diffuse scattering layer can be printed in areas where light extraction is desired. The size and density of the optical scattering components can be adjusted to achieve the desired amount of light extraction. In some embodiments the size of an optical scattering component is on the order of the wavelength of the light to be extracted, e.g., primary electromagnetic radiation, secondary electromagnetic radiation, etc. In some embodiments where the light is visible light, the optical scattering component may have an average particle size of about 300 nm to about 500 nm. Optical scattering components that are incorporated into the bulk volume of the energy conversion layer can produce light extraction from the energy conversion layer. Such optical scattering components may also, in some embodiments, increase the effective path length of interaction of the primary electromagnetic radiation with the photoluminescent material of the energy conversion layer. Optical scatterers may also, in some embodiments, increase the effective path length of interaction of the secondary electromagnetic radiation with the photoluminescent material of the energy conversion layer and cause the secondary electromagnetic radiation to be further converted to a tertiary electromagnetic radiation (e.g., having a still longer peak or average wavelength). Such increase in effective path length of the primary and/or secondary electromagnetic radiation can reduce the concentration of photoluminescent material that is required to achieve a particular effect or result. Optical scattering components are typically materials that lack significant optical absorption, but have a refractive index significantly different from the carrier medium. Suitable optical scattering materials may include titanium dioxide (titania), zirconium oxide (zirconia), barium sulfate, and hollow glass spheres. In some embodiments, the energy conversion layer may include both the optical scattering components and the optical structures that are etched or embossed onto a surface of the energy conversion layer. In some embodiments an optical scattering component is present in a concentration of at least 1×10¹¹ particles/cm³, at least 6×10¹¹ particles/cm³, at least 1×10¹² particles/cm³, about 1×10¹¹ particles/cm³, about 6×10¹¹ particles/cm³, or about 1×10¹² particles/cm³ of the energy conversion layer. In some embodiments the uniformity of the intensity of the extracted light is dependent on the distribution of the optical scattering components. Accordingly, in some embodiments optical scattering components are clustered in one or more discrete portions of the energy conversion layer.

In some embodiments the illumination system includes one or more additional layers. In some embodiments an additional layer may be adjacent or abut at least a portion of one or both of the bottom and viewing surfaces of the energy conversion layer. For example, an additional layer may comprise one or more of a reflective layer, a diffusion layer, a diffuse reflective layer, a stability layer, etc. In some embodiments a diffuse reflector is a form of reflector that produces reflection over a range of angles that include the specular angle. In general, guided light that is reflected at the specular angle remains guided. In other embodiments a more efficient diffuser will produce a somewhat larger angular dispersion, but will reflect less light at the specular angle. For example, one embodiment may include a reflective layer on the bottom (non-viewing) surface and a stability enhancing layer on the top (viewing) surface.

In some embodiments the illumination system comprises a reflective layer. A reflective layer may redirect at least a portion of incident radiation away from the surface of the reflective layer. For example, a reflective layer may be desired to aid in light guiding by preventing outcoupling from a non-preferred face, such as the bottom surface. In some such embodiments the reflector may be a specular reflector, such as a metallic coating, to prevent unintended scattering and extraction from the conversion film.

In some embodiments the illumination system comprises a diffuse reflector. For example, in some regions where extraction of light (e.g., primary and/or secondary electromagnetic radiation) is desired, a diffuse reflector can aid the light extraction and can redirect light into a viewing hemisphere, and may be disposed on the non-viewing side of the illumination system. In some embodiments the illumination system includes a layer to provide protection and stability to the energy conversion layer.

In some embodiments the illumination system comprises a diffusion layer. A diffusion layer may increase or substantially increase the optical scattering of at least a portion of the radiation, such as primary electromagnetic radiation, secondary electromagnetic radiation, or ambient radiation.

In some embodiments the additional layer of the illumination system (e.g., reflector, diffuse reflector, diffuser, stability layer, etc.) has a refractive index that is approximately the same as that of the energy conversion layer; in such embodiments the additional layer can be considered to be part of the light guide structure. Alternatively, in some embodiments where the film includes embossed structures to aid with light extraction, there may be a sufficient difference in refractive index between the energy conversion layer and the additional layer to achieve the refraction from the surface that is desired. In this case, an additional layer having a significantly lower refractive index (e.g., about 0.1 to about 0.4 lower, about 0.2 to about 0.3 lower, at least 0.1 lower, at least 0.2 lower, at least 0.3 lower, or at least 0.4) may be beneficial. In some embodiments an additional layer may comprise a fluoropolymer or an aliphatic silicone.

Edge-Injected, Optically Decoupled

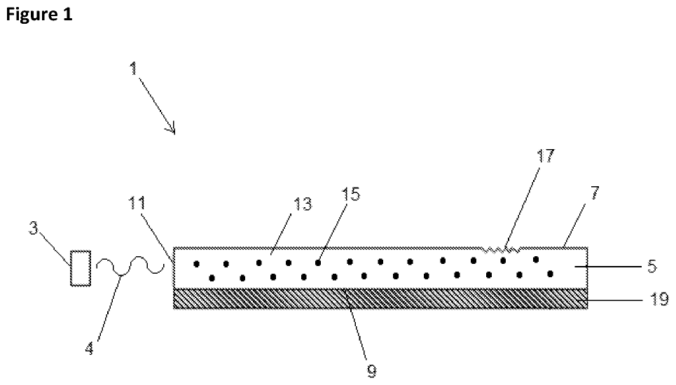

Referring to FIG. 1, in an embodiment an illumination system 1 includes an illumination source 3 that emits a primary electromagnetic radiation 4, and an energy conversion layer 5. The energy conversion layer has a viewing surface 7, a bottom surface 9 opposed to the viewing surface 7, and an edge surface 11 substantially normal to the viewing surface 7 and bottom surface 9. The energy conversion layer 5 comprises a matrix material 13 and a photoluminescent material 15 with an absorption spectrum that at least partially overlaps with the spectrum of the primary radiation 4. The illumination source 3 is optically decoupled from the energy conversion layer 5. The illumination source 3 emits a primary radiation 4 in the direction of, and incident on, the edge surface 11 of energy conversion layer 5. An optical scattering component 17 is disposed on the viewing surface 7. A reflective layer 19 may be coupled to the bottom surface 9. Due to the ability of a diffuse reflector to redirect guided modes into modes that are essentially perpendicular to the surface of the film, and therefore extracted from the waveguide, in some embodiments it may be desirable to use a specular reflector.

In this case, primary electromagnetic radiation 4 light from the illumination source 3 is introduced into the edge surface 11 of the energy conversion layer 5 such that a majority of the primary electromagnetic radiation 4 is guided within the energy conversion layer 5. The primary electromagnetic radiation 4 is absorbed by the photoluminescent material 15 in the energy conversion layer 5, which in turn emit the energy at longer wavelengths. As described earlier, approximately 75% of this converted light is constrained and guided in the energy conversion layer 5 by total internal reflection at the viewing surface 7, and by reflection from the specular reflector 19 at the bottom surface 9. If the absorption spectrum of the photoluminescent material 15 overlaps with its optical emission, then this spectrum (defined by the overlap) can be reabsorbed and converted to the longer wavelength emission until the spectrum of the guided light contains only wavelengths that cannot be absorbed, to produce a light of uniform color. Light can be transmitted through the energy conversion layer 5 (acting as a waveguide) until it reaches a region that has an optical scattering component 17 such as roughening or is otherwise designed to extract the converted light. The extraction can be accomplished by producing the energy conversion layer 5 with optical scattering components 17, e.g., embossed structures, in regions where light extraction is desired. Similarly, optical scattering components 17 for light extraction can be produced by laser etching. Alternatively, diffuse scattering materials can be printed or laminated in the regions of the desired extraction. Not shown in FIG. 1 are additional layers that may provide protection or stability. If the additional (e.g., stability) layer is meant to go over structures embossed in the surface of the energy conversion film, such additional (e.g., stability) layers must be produced using materials with a significantly lower refractive index than that used for the energy conversion film.

In cases where the primary radiation is provided at an edge of the energy conversion film, it can be advantageous for the illumination source 3 to be optically decoupled from the edge surface 11, since refraction at the boundary between air and the energy conversion layer 5 will tend to direct rays of the primary electromagnetic radiation 4 into directions that are preferred for light guiding. In some such embodiments, additional diffusion as described above is not needed to redirect non-guided rays into geometries in which they would be guided, and may be avoided to prevent unintended redirection of rays of primary electromagnetic radiation 4 into non-guided modes.

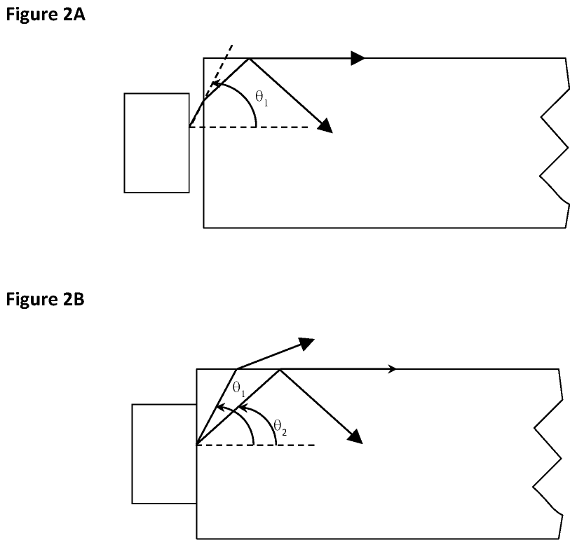

In some such embodiments of the illumination system where the illumination source 3 faces but is not optically coupled to the edge surface 11 where the light injection is occurring, then the rays of the primary electromagnetic radiation 4 arising from the illumination source 3 are modified by refraction at the edge surface 11 of the energy conversion layer. This refraction may cause the rays to be bent such that they are more likely to be constrained and guided within the energy conversion film 5. As a result, in some embodiments of this geometry, it may be desirable for the illumination source 3 to be as close as possible, but decoupled from the energy conversion layer 5. In some embodiments the illumination source 3 is separated from the energy conversion layer 5 by a distance of less than 3 mm, less than 2 mm, less than 1 mm, less than 0.5 mm, less than 0.1 mm, between about 0.1 mm and about 3 mm, about 0.5 mm and 3 mm, or about 1 mm and 2 mm. This can be seen in the embodiment illustrated in FIG. 2a, that shows an illumination source 3 that is not optically coupled to the edge surface 11 of the energy conversion layer 5. In comparison, FIG. 2b shows an embodiment where an illumination source 3 is optically coupled to the edge surface 11 of the energy conversion film 5. In FIG. 2a, θ₁ is the angle of a ray of the primary electromagnetic radiation 4 exiting the face of the illumination source 3 that can produce the critical angle in the matrix material 13 of the energy conversion layer 5. In FIG. 2b, this same ray is not totally internally reflected and can exit the viewing surface 7 of the energy conversion layer 5. The angle must be reduced to θ₂ to achieve total internal reflection and waveguiding when the illumination source 3 is optically coupled to edge surface 11 of the energy converting layer 5.

Edge-Injected Optically Coupled

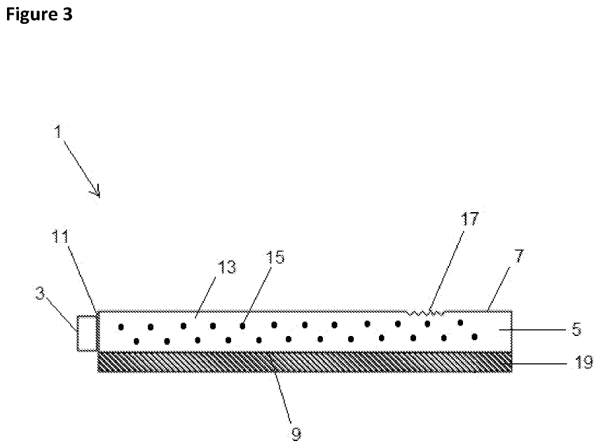

Referring to FIG. 3 an embodiment of the illumination system includes an illumination source 3 of the primary electromagnetic radiation optically coupled to the edge surface 11 of the energy conversion layer 5. This embodiment will guide at least a portion of the primary electromagnetic radiation in the energy conversion layer, however less light from the illumination source 3 of the primary electromagnetic radiation 4 may be guided in the energy conversion layer 5 compared to an embodiment wherein the illumination source directs the primary electromagnetic radiation to the edge surface of the energy conversion layer but is decoupled from the energy conversion layer.

Bottom-Injected Optically Decoupled

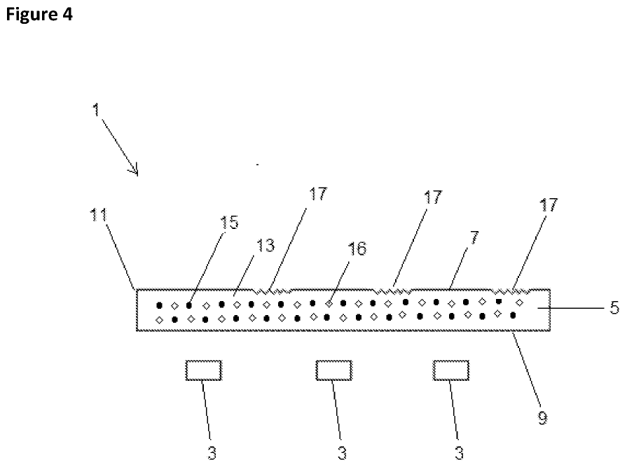

Referring to FIG. 4, in an embodiment an illumination system 1 includes a plurality of illumination sources 3 that emit a primary electromagnetic radiation 4, and an energy conversion layer 5. The energy conversion layer has a viewing surface 7, a bottom surface 9 opposed to the viewing surface 7, and an edge surface 11 substantially normal to the viewing surface 7 and bottom surface 9. The one or more illumination sources 3 are optically decoupled from the energy conversion layer 5. The one or more illumination sources 3 emits a primary radiation 4 in the direction of, and incident on, the bottom surface 9 of energy conversion layer 5. The energy conversion layer 5 comprises a matrix material 13 and a photoluminescent material 15 with an absorption spectrum that at least partially overlaps with the spectrum of the primary radiation 4. The energy conversion layer 5 further comprises optical scattering material 16, so as to redirect at least a portion of the primary electromagnetic radiation 4 into guided modes. The concentration of optical scatterers 16 may be high enough to achieve the desired guiding of the primary electromagnetic radiation 4, but low enough to avoid undesirable light extraction. The concentration of optical scatterers 16 may be determined, for example, by experimentation. The concentration of the photoluminescent material 15 and the optical scatterers 16 may be optimized to achieve the desired spectral effect. Since the scattering concentration must be kept reasonably low, optical scattering components 17 for light extraction may be included on the viewing surface 7 between the illumination sources 3 to facilitate desired extraction. Optical scattering components 17 can include embossed or etched surface structures, or may be diffuse scattering materials that are printed or laminated in the desired regions of light extraction. Not shown in FIG. 4 are additional layers that may provide protection or stability. If the additional layer is meant to go over structures embossed in the surface of the energy conversion film, such layers may be produced using materials with a significantly lower refractive index than that used for the energy conversion layer 5.

Bottom-Injected Optically Coupled

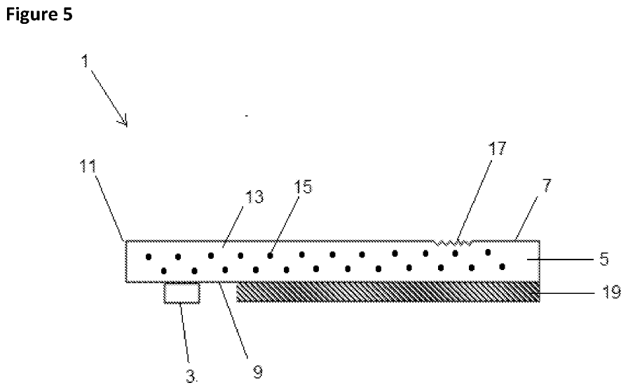

Referring to FIG. 5, in an embodiment an illumination system 1 includes an illumination source 3 that emits a primary electromagnetic radiation 4, and an energy conversion layer 5. The energy conversion layer has a viewing surface 7, a bottom surface 9 opposed to the viewing surface 7, and an edge surface 11 substantially normal to the viewing surface 7 and bottom surface 9. The energy conversion layer 5 comprises a matrix material 13 and a photoluminescent material 15 with an absorption spectrum that at least partially overlaps with the spectrum of the primary radiation 4. The illumination source 3 is optically coupled to the bottom surface 9 of energy conversion layer 5. The illumination source can be coupled to the energy conversion film with an optical adhesive, such as an acrylic adhesive or a silicone. Alternatively, the illumination system may be prepared with the illumination source embedded into the bottom surface of the energy conversion layer. An optical scattering component 17 is disposed on the viewing surface 7. A reflective layer 19 is coupled to a portion of the bottom surface 9. Reflective layer 19 may be, for example, a specular reflector and may be sized to cover less than the entire bottom surface 9. Illumination source 3, in some embodiments, may be coupled to a portion of bottom surface 9 which is not coupled to reflection layer 19. In some embodiments, some or all portions of bottom surface 9 that are not coupled to an illumination source 3 may be covered by reflection layer 19. Some such embodiments may be used to convert a primary electromagnetic radiation to a secondary electromagnetic radiation of a uniform color. In some such embodiments, most of the primary electromagnetic radiation 4 is constrained in and guided in the energy conversion layer 5 by total internal reflection. Furthermore, in some such embodiments, the primary electromagnetic radiation 4 is absorbed by the photoluminescent material 15, and emitted at longer wavelengths. The emitted light is also mostly constrained by and guided in the energy conversion layer 5 and further modified by additional absorption and emission by the photoluminescent material 15 until the guided light is of uniform color. Light extraction may be accomplished optical scattering component 17. Not shown in FIG. 5 are additional layers that may provide protection or stability. If the additional layer is meant to go over structures embossed in the surface of the energy conversion film, such layers must be produced using materials with a significantly lower refractive index than that used for the matrix 13 of energy conversion layer 5.

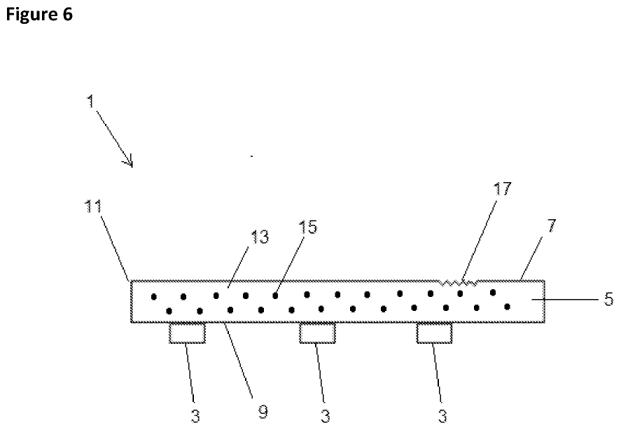

Referring to FIG. 6, in an embodiment an illumination system 1 includes a plurality of illumination sources 3 that emit a primary electromagnetic radiation 4, and an energy conversion layer 5. The energy conversion layer has a viewing surface 7, a bottom surface 9 opposed to the viewing surface 7, and an edge surface 11 substantially normal to the viewing surface 7 and bottom surface 9. The energy conversion layer 5 comprises a matrix material 13 and a photoluminescent material 15 with an absorption spectrum that at least partially overlaps with the spectrum of the primary radiation 4. The illumination sources 3 are optically coupled to the bottom surface 9 of energy conversion layer 5. The illumination sources can be coupled to the energy conversion film with an optical adhesive, such as an acrylic adhesive or a silicone. Alternatively, the illumination system may be prepared with the illumination sources embedded into the bottom surface of the energy conversion layer. An optical scattering component 17 is disposed on the viewing surface 7. Optical scattering elements 17 can be included in the regions between the sources so that the spectrum of the extracted light can include both the primary electromagnetic radiation and the converted radiation (e.g., secondary electromagnetic radiation). In this embodiment the light may be extracted before all of the primary electromagnetic radiation 4 can be converted, allowing for a mixture of the primary electromagnetic radiation 4 and secondary electromagnetic radiation to be emitted from the viewing surface 7 (e.g., optical scattering components 17 on the viewing surface 7). Optical scattering elements 17 can include embossed or etched surface structures, or may be diffuse scattering materials that are printed or laminated in the desired regions of light extraction. Not shown in FIG. 6 are additional layers that may provide protection or stability. If the additional layer is meant to go over structures embossed in the surface of the energy conversion film, such layers may be produced using materials with a significantly lower refractive index than that used for the energy conversion film.

While not shown in FIG. 6, the embodiment of FIG. 6 may also include a reflective layer coupled to a portion of the bottom surface 9. The reflective layer may be, for example, a specular reflector and may be sized to cover less than the entire bottom surface 9. Illumination sources 3, in some embodiments, may be coupled to a portion or portions of bottom surface 9 which is/are not coupled to the reflection layer. In some embodiments, some or all portions of bottom surface 9 that are not coupled to the illumination sources 3 may be covered by a reflection layer.

Although only a few embodiments of the invention have been described above, it should be appreciated that many modifications can be made without departing from the spirit and scope of the invention. For example, any of the elements described herein may be independently combined to form additional embodiments and all such modifications are intended to be included in the present invention. For example, in another embodiment an illumination system may include an energy conversion layer having an edge surface and a bottom surface and may include one or more illumination sources that direct the primary electromagnetic radiation to be incident on the edge surface and one or more illumination sources that direct the primary electromagnetic radiation to be incident on the bottom surface.

### EXAMPLE

In an example, the light guiding effect of the energy conversion layer when the illumination source is coupled to the energy conversion layer can be effectively demonstrated by first coupling an illumination source 3, such as a blue LED, to a candidate energy conversion layer matrix material 13, such as a PMMA film, using a refractive index matching oil, such as those provided by Cargille Labs. Guiding is then shown by measuring the out-coupling from the film using a glass prism that is similarly coupled to the film. Losses, due to optical absorption or elastic scattering, in the internal transmission can be assessed by measuring the intensity of the out-coupled light at several distances from the source and comparing the result with what would be expected based on the “distance-squared” law, that is, the principle that the intensity of light at a point a distance from the light source is inversely proportional to the square of the distance from the light source to the point.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

I/we claim:

1. An illumination system comprising:
an illumination source that emits a primary electromagnetic radiation having a spectrum of wavelengths; and
an energy conversion layer that converts at least a portion of the primary electromagnetic radiation to a secondary electromagnetic radiation having a different spectrum of wavelengths than the primary electromagnetic radiation,
wherein the energy conversion layer has a viewing surface, a bottom surface opposed to the viewing surface, and an edge surface normal to the viewing surface and the bottom surface, and
wherein the primary electromagnetic radiation is incident on the edge surface of the energy conversion layer.

2. The illumination system of claim 1, wherein the energy conversion layer comprises a photoluminescent material dispersed in a matrix material.

3. The illumination system of claim 2, wherein the photoluminescent material has an absorption spectrum that overlaps with at least a portion of the spectrum of wavelengths of the primary electromagnetic radiation.

4. The illumination system of claim 3, wherein the photoluminescent material comprises a dye.

5. The illumination system of claim 4, wherein the dye comprises an organic fluorescent dye.

6. The illumination system of claim 5, wherein the organic fluorescent dye is selected from rylenes, xanthenes, porphyrins, and phthalocyanines.

7. The illumination system of claim 1, wherein the energy conversion layer receives and propagates the primary electromagnetic radiation by total internal reflection.

8. The illumination system of claim 7, wherein the primary electromagnetic radiation propagates with a total internal reflection of about 70% or more of the primary electromagnetic radiation.

9. The illumination system of claim 7, wherein the energy conversion layer propagates the secondary electromagnetic radiation with a total internal reflection of about 70% or more of the secondary electromagnetic radiation.

10. The illumination system of claim 1, wherein the energy conversion layer further comprises a scattering component.

11. The illumination system of claim 1, wherein the illumination source is optically decoupled from the energy conversion layer.

12. The illumination system of claim 11, wherein the illumination source is separated from the energy conversion layer by a layer of air, nitrogen, noble gas, other gas, or mixture thereof, or vacuum.

13. The illumination system of claim 11, wherein the illumination source is separated from the energy conversion layer by a distance of less than 3 mm.

14. The illumination system of claim 1, wherein the illumination source is optically coupled to the energy conversion layer.

15. The illumination system of any one of claims 1-14, further comprising a reflective layer covering at least a portion of the bottom surface of the energy conversion layer.

16. The illumination system of any one of claims 1-14, further comprising a diffusion layer covering at least a portion of the viewing surface of the energy conversion layer.

17. The illumination system of any one of claims 1-14, further comprising an optical scattering component.

18. The illumination system of claim 17, wherein the optical scattering component is disposed on a surface of the energy conversion layer.

19. The illumination system of claims 17, wherein the optical scattering component is disposed within the energy conversion layer.

20. The illumination system of claim 17, wherein the optical scattering component comprises titanium dioxide, zirconium dioxide, barium sulfate, glass, or a combination thereof.

21. An illumination system comprising:
an illumination source that emits a primary electromagnetic radiation having a spectrum of wavelengths;
an energy conversion layer that converts at least a portion of the primary electromagnetic radiation to a secondary electromagnetic radiation having a different spectrum of wavelengths than the primary electromagnetic radiation; and
an optical element that guides the primary electromagnetic radiation into the energy conversion layer,
wherein the energy conversion layer has a viewing surface, a bottom surface opposed to the viewing surface, and an edge surface normal to the viewing surface and the bottom surface,
wherein the primary electromagnetic radiation is incident on the bottom surface of the energy conversion layer, and
wherein the illumination source is optically decoupled from the energy conversion layer.

22. The illumination system of claim 21, wherein the energy conversion layer comprises a photoluminescent material dispersed in a matrix material.

23. The illumination system of claim 22, wherein the photoluminescent material has an absorption spectrum that overlaps with at least a portion of the spectrum of wavelengths of the primary electromagnetic radiation.

24. The illumination system of claim 23, wherein the photoluminescent material comprises a dye.

25. The illumination system of claim 24, wherein the dye comprises an organic fluorescent dye.

26. The illumination system of claim 25, wherein the organic fluorescent dye is selected from rylenes, xanthenes, porphyrins, and phthalocyanines.

27. The illumination system of claim 21, wherein the energy conversion layer receives and propagates the primary electromagnetic radiation by total internal reflection.

28. The illumination system of claim 27, wherein the primary electromagnetic radiation propagates with a total internal reflection of about 70% or more of the primary electromagnetic radiation.

29. The illumination system of claim 27, wherein the energy conversion layer propagates the secondary electromagnetic radiation with a total internal reflection of about 70% or more of the secondary electromagnetic radiation.

30. The illumination system of claim 21, wherein the energy conversion layer comprises a scattering component.

31. The illumination system of claim 21, wherein the optical element comprises a refractive element.

32. The illumination system of claim 21, wherein the optical element comprises a prism.

33. The illumination system of claim 21, wherein the optical element comprises a lens.

34. The illumination system of any one of claims 21-33, further comprising a reflective layer covering at least a portion of the bottom surface.

35. The illumination system of any one of claims 21-33, further comprising a diffusion layer covering at least a portion of the viewing surface.

36. The illumination system of any one of claims 21-33, wherein the illumination source is separated from the energy conversion layer by a layer of air, nitrogen, noble gas, other gas, or mixture thereof, or vacuum.

37. An illumination system comprising:
an illumination source that emits a primary electromagnetic radiation having a spectrum of wavelengths, and
an energy conversion layer that converts at least a portion of the primary electromagnetic radiation to a secondary electromagnetic radiation having a different spectrum of wavelengths than the primary electromagnetic radiation,
wherein the energy conversion layer has a viewing surface, a bottom surface opposed to the viewing surface, and an edge surface normal to the viewing surface and the bottom surface,
wherein the primary electromagnetic radiation is incident on a bottom surface of the energy conversion layer,
wherein the energy conversion layer is optically coupled to the illumination source; and
wherein the illumination source is optically coupled to the bottom surface of the energy conversion layer.

38. The illumination system of claim 37, wherein the energy conversion layer comprises a photoluminescent material dispersed in a matrix material.

39. The illumination system of claim 38, wherein the photoluminescent material has an absorption spectrum that overlaps with at least a portion of the spectrum of wavelengths of the primary electromagnetic radiation.

40. The illumination system of claims 39, wherein the photoluminescent material comprises a dye.

41. The illumination system of claim 40, wherein the dye comprises an organic fluorescent dye.

42. The illumination system of claim 41, wherein the organic fluorescent dye is selected from rylenes, xanthenes, porphyrins, and phthalocyanines.

43. The illumination system of claims 37, wherein the energy conversion layer receives and propagates the primary electromagnetic radiation by total internal reflection.

44. The illumination system of claim 43, wherein the primary electromagnetic radiation propagates with a total internal reflection of about 70% or more of the primary electromagnetic radiation.

45. The illumination system of claim 43, wherein the energy conversion layer propagates the secondary electromagnetic radiation with a total internal reflection of about 70% or more of the secondary electromagnetic radiation.

46. The illumination system of any one of claims 37-45, wherein the energy conversion layer further comprises an optical scattering component.

47. The illumination system of any one of claims 37-45, further comprising a reflective layer covering at least a portion of the bottom surface.

48. The illumination system of any one of claims 37-45, further comprising a diffusion layer covering at least a portion of the viewing surface.

49. The illumination system of any one of claims 37-45, wherein the illumination source abuts the energy conversion layer.
